(19) United States
(12) Patent Application Publication
(10) Pub. No.: US 2015/0261935 A1
(43) Pub. Date: Sep. 17, 2015

(54) Systems and Methods for Verifying Correlation of Diagnosis and Medication as Part of Qualifying Program Eligibility Verification

(71) Applicant: McKesson Financial Holdings, Hamilton (BM)

(72) Inventor: Kristina Crockett, Atlanta, GA (US)

(73) Assignee: MCKESSON FINANCIAL HOLDINGS, Hamilton (BM)

(21) Appl. No.: 14/206,224

(22) Filed: Mar. 12, 2014

(51) Int. Cl. G06F 19/00

(52) U.S. Cl. CPC G06F 19/3475; G06F 19/328

(57) ABSTRACT

Systems and methods are provided for verifying correlation of diagnosis and medication as part of qualifying program eligibility verification for a medication requested in a healthcare transaction. A service provider computer may receive an ADT transaction from a covered entity healthcare provider that includes patient identifiers identifying a patient and a diagnosis code identifying a malady affecting a the patient. The service provider computer may receive a healthcare claim transaction from a pharmacy requesting a medication for the patient. The service provider computer can verify that the requested medication is one typically used for the malady identified by the diagnosis code. The service provider computer may also determine whether the requested medication is eligible under a predefined qualifying program based at least in part on the healthcare claim transaction and patient and/or prescriber registration information.

### TECHNICAL FIELD

Aspects of the disclosure relate generally to systems and methods for qualified plans eligibility verification for purchase of prescription medication and more particularly to verifying the prescribed medication is one for treating a diagnosed malady of the patient as part of the eligibility verification.

### BACKGROUND OF THE INVENTION

There are various government sponsored and non-government sponsored predefined qualified programs associated with the distribution of prescription products, such as medications and medical devices. These predefined qualified programs may include, for example, the federal 340B program, section 602 pricing, group purchasing organizations (GPO) program, patient assistance program (PAP), Medicare, or Medicaid.

As an example predefined qualifying program, Section 340B of the Public Health Services Act was enacted by Congress under Section 602 of the Veterans Healthcare Act of 1992. Prescription drug purchases under Section 340B have the potential to reduce the overall cost of patient care by reducing the cost of prescribed medications to patient. However, managing 340B medication disbursements and eligibility verification is difficult for prescribing organizations, such as healthcare facilities and participating pharmacies. In particular, when prescriptions are received by participating pharmacies, the participating pharmacy may need to verify if the prescription is eligible for 340B pricing. Ensuring proper eligibility is necessary to limit fraudulent purchases under the predefined qualified programs, such as the 340B Program,

### BRIEF DESCRIPTION OF THE DRAWINGS

Reference will now be made to the accompanying drawings, which are not necessarily drawn to scale, and wherein:

FIG. 1 illustrates an example system for verifying correlation of diagnosis and medication as part of qualifying program eligibility verification in accordance with certain example embodiments of the disclosure.

FIGS. 2A and 2B is a diagram of example data flows for verifying correlation of diagnosis and medication as part of a qualifying program eligibility verification of a healthcare transaction processed through a service provider in accordance with certain example embodiments of the disclosure.

FIGS. 3A and 3B are a flow chart of an example method for verifying correlation of diagnosis and medication as part of a qualifying program eligibility verification of a healthcare transaction in accordance with certain example embodiments of the disclosure.

### DETAILED DESCRIPTION OF EXAMPLE EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods that facilitate the verification of a prescription to determine if the associated product disbursement is in compliance with terms of a qualifying program and that the prescribed medication is one normally prescribed to treat the current diagnosed malady for a patient. The prescription may be generated and presented to a pharmacy by a covered entity or patient and the pharmacy, via a pharmacy computer, may, in turn, request a service provider, via a service provider computer, to verify that the prescription is eligible under the qualifying program and that the prescribed medication is one normally prescribed to treat the current diagnosed malady for a patient. The service provider computer may determine if the prescription is eligible under the qualifying program based at least in part on information received by the service provider computer from one of at least the covered entity computer or the pharmacy computer. The service provider computer may also determine if the prescribed medication is one normally prescribed to treat the current diagnosed malady for a patient based at least in part on information received by the service provider computer from one or more of the pharmacy computer, the covered entity computer, or a computer associated with the service provider computer. Therefore the service provider computer may gain access to information associated with or from a patient, a prescriber, a covered entity, or a pharmacy, to make a determination on correlation of prescribed medication to patient diagnosis, billing, disbursement, and program eligibility of products identified in the prescription. The service provider computer may further provide an indication of the eligibility of the prescription under the qualifying program to the pharmacy computer. Based in part on the eligibility of the prescription under the qualifying program, the pharmacy may disburse the product associated with the prescription to a patient of the covered entity.

Example embodiments of the disclosure may support disbursement of products identified in the prescription to patients in compliance with the qualifying program. In general, the qualifying program may provide contractual terms between a prescribing organization/entity/provider (“covered entity”) and one or more pharmacies (“contracting pharmacy”). According to certain example embodiments, the covered entity may contract with one or more contracted pharmacies to fill one or more prescriptions on behalf of the covered entity.

The contractual terms between the covered entity and the contracting pharmacy may be based upon, but is not limited to, the terms of the qualifying program, such as Section 340B of the Public Health Services Act or other similar programs (“340B program”). According to an example embodiment, a covered entity that participates in a 340B program can obtain significant discounts from pharmaceutical manufacturers or distributors on prescription medications or products. As described herein, to obtain these discounts on prescription medications or products, a covered entity may contract with a contracting pharmacy to fill certain prescriptions for patients of the covered entity. To support the filling of these prescriptions, systems and methods for verifying the eligibility of a prescription under the qualifying program based at least in part on patient or clinical information received by the service provider computer and verifying that the prescribed medication is one normally prescribed to treat the current diagnosed malady for a patient is disclosed herein.

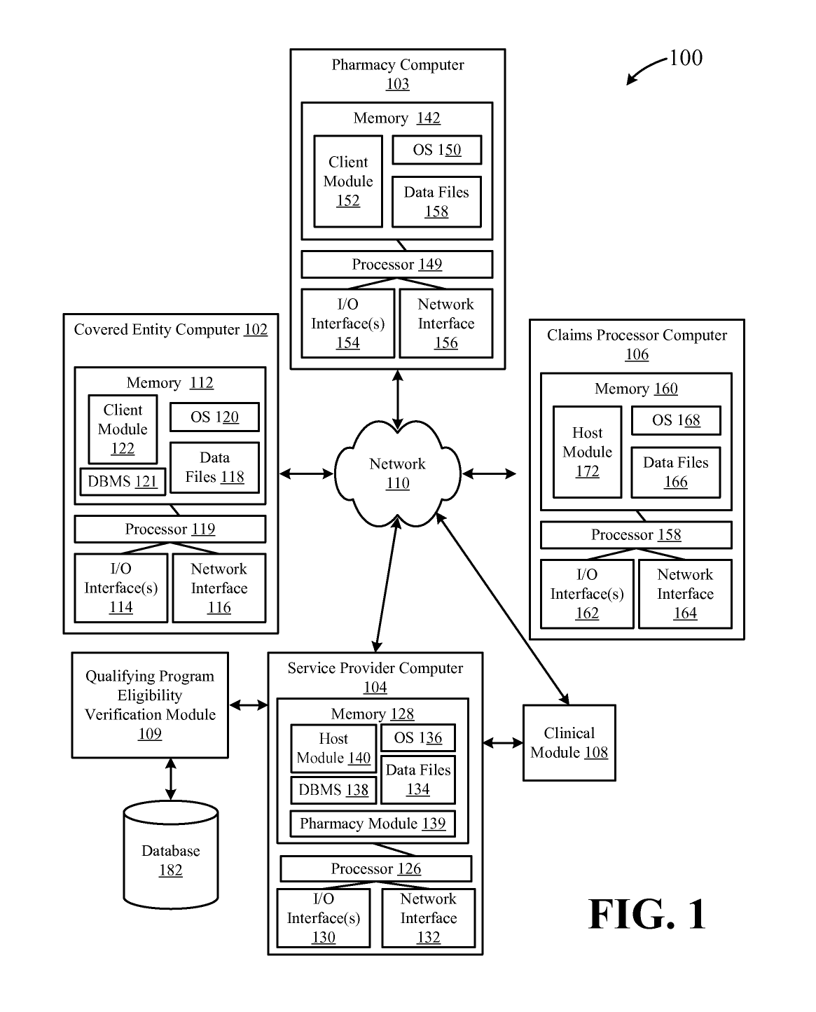

FIG. 1 illustrates an example system 100 for verifying correlation of diagnosis and medication as part of qualifying program eligibility verification in accordance with certain example embodiments of the disclosure. As shown in FIG. 1, the system 100 may include a covered entity computer 102, a pharmacy computer 103, a service provider computer 104, a claims processor computer 106 and a clinical module/computer 108, which are each configured for accessing and reading associated computer-readable media having stored thereon data and/or computer-executable instructions for implementing the various methods disclosed by the example embodiments herein. Generally, network devices and systems, including the one or more covered entity computers 102, pharmacy computers 103, service provider computers 104, claims processor computers 106, and clinical module/computer 108 have hardware and/or software for transmitting and receiving data and/or computer-executable instructions over a communications link and a memory for storing data and/or computer-executable instructions. These network devices and systems may also include a processor for processing data and executing computer-executable instructions, as well as other internal and peripheral components that are well known in the art. As used herein, the term “computer-readable medium” may describe any form of memory or a propagated signal transmission medium. Propagated signals representing data and computer program instructions may be transferred between network devices and systems.

As shown in FIG. 1, the covered entity computer 102, pharmacy computer 103, service provider computer 104, claims processor computer 106, and clinical module/computer 108 may be in communication with each other via a network 110, which as described below can include one or more separate or shared private and public networks, including the Internet or a publicly switched telephone network. The covered entity computer 102 may be associated with (i.e., located within) or operated by and/or from a covered entity, which may include, but is not limited to, a federally-qualified health center as defined in (see, e.g., 1905(I)(2)(B) of the Social Security Act (SSA)), a family planning entity, a State-operated AIDS Drug Assistance Program, a disproportionate share hospital as defined in (see, e.g., section 1886(d)(1)(B) of the SSA), and the like. The pharmacy computer 103 may be associated with (i.e., located within) or operated by and/or from a contracting pharmacy. Each of these components—the covered entity computer 102, the pharmacy computer 103, the service provider computer 104, the claims processor computer 106, the clinical module/computer 108, and the network 110—will now be discussed in further detail.

The covered entity computer 102 may be any processor-driven device, such as, but not limited to, a server computer, a mainframe computer, one or more networked computers, a desktop computer, a personal computer, a laptop computer, a mobile computer, a handheld portable computer, a digital assistant, a personal digital assistant, a digital tablet, an Internet appliance, or any other processor-based device. In addition to having a processor 119, the covered entity computer 102 may further include a memory 112, input/output (“I/O”) interface(s) 114 and a network interface 116. The memory 112 may be any computer-readable medium, coupled to the processor 119, such as random access memory (RAM), read-only memory (ROM), and/or a removable storage device for storing data files 118 and a database management system (“DBMS”) 121 to facilitate management of data files 118 and other data stored in the memory 112 and/or stored in separate databases. The memory 112 may store data files 118 and various program modules, such as an operating system (“OS”) 120 and a client module 122. The OS 120 may be, but is not limited to, Microsoft Windows®, Apple OSX™, Unix, Linux or any other currently existing or future developed operating system.

The client module 122 may be an Internet browser or other software, including a dedicated program, for interacting with the service provider computer 104, the clinical module/computer 108, and/or pharmacy computer 103. For example, a physician or other healthcare provider may utilize the client module 122 in providing an electronic prescription order for a patient for delivery to a designated pharmacy computer 103 via the service provider computer 104 and the network 110, according to an example embodiment of the disclosure. In another example embodiment, the physician or other healthcare provider may utilize the client module 122 or another portion of the covered entity computer 102 to provide a healthcare transaction covering patient visit information at the covered entity (i.e., an Admit, Discharge, Transfer (ADT) transaction) to the clinical module/computer 108 and/or the service provider computer 104 via the network 110. Furthermore, the physician or other healthcare provider may utilize the client module 122 or another portion of the covered entity computer 102 to receive data and/or responses from the pharmacy computer 103 and/or the service provider computer 104.

Still referring to the covered entity computer 102, the I/O interface(s) 114 may facilitate communication between the processor 119 and various I/O devices, such as a keyboard, mouse, printer, microphone, speaker, monitor, bar code readers/scanners, RFID readers, and the like. The network interface 116 may take any of a number of forms, such as a network interface card, a modem, a wireless network card, and the like. It will be appreciated that while the covered entity computer 102 has been illustrated as a single computer or processor, the covered entity computer 102 may be comprised of a group of computers or processors, according to certain example embodiments of the disclosure.

The example pharmacy computer 103 may be any processor-driven device, such as a server computer, a mainframe computer, one or more networked computers, a desktop computer, a personal computer, a laptop computer, a mobile computer, a handheld portable computer, a digital assistant, a personal digital assistant, a digital tablet, an Internet appliance, or any other processor-based device. In certain example embodiments, the pharmacy computer 103 can be located within a pharmacy, such as a contracted pharmacy. In addition to having a processor 149, the pharmacy computer 103 may further include a memory 142, input/output (“I/O”) interface(s) 154, and a network interface 156. The memory 142 may store data files 158 and various program modules, such as an operating system (“OS”) 150 and a client module 152. The memory 142 may be any computer-readable medium, coupled to the processor 149, such as RAM, ROM, and/or a removable storage device for storing data files 158 and a database management system (“DBMS”) to facilitate management of data files 158 and other data stored in the memory 142 and/or stored in separate databases. The OS 150 may be any currently existing or future-developed operating system including, but not limited to, Microsoft Windows®, Apple OSX™, Unix, or Linux. The client module 152 may be an Internet browser or other software, including a dedicated program, for interacting with the covered entity computer 102, the service provider computer 104, the clinical module/computer 108 and/or the claims processor computer 106. For example, a user of the pharmacy computer 103, such as a pharmacist or other pharmacy employee, may utilize the client module 152 or another portion of the pharmacy computer 103 to receive or retrieve an electronic prescription transaction (e.g., e-prescription transaction (i.e., electronic prescription order transaction, e-script, or e-prescription) from the covered entity computer 102 via the service provider computer 104 and the network 110. Likewise, the pharmacist or other pharmacy employee may utilize the client module 152 or another portion of the pharmacy computer 103 in preparing and transmitting a healthcare claim transaction (e.g., a prescription claim or billing request or healthcare order transaction) (together with the electronic prescription transaction, a healthcare transaction) to the service provider computer 104 via the network 110 for delivery to the appropriate claims processor computer 106. The pharmacy computer 103 may also utilize the client module 152 or another portion of the pharmacy computer 103 to retrieve or otherwise receive data or responses from the service provider computer 104. The pharmacy computer 103 may further utilize the client module 152 or another portion of the pharmacy computer 103 to transmit prescription information (including one or more patient identifiers, one or more medication identifiers, one or more prescriber identifiers, and one or more healthcare provider identifiers (identifying a covered entity)) to and request qualifying program eligible prescription verification from the service provider computer 104.

Still referring to the pharmacy computer 103, the I/O interface(s) 154 may facilitate communication between the processor 149 and various I/O devices, such as a keyboard, mouse, printer, microphone, speaker, monitor, bar code readers/scanners, RFID readers, and the like. The network interface 156 may take any of a number of forms, such as a network interface card, a modem, a wireless network card, and the like. It will be appreciated that while the pharmacy computer 103 has been illustrated as a single computer or processor, the pharmacy computer 103 may be comprised of a group of computers or processors, according to certain example embodiments of the disclosure.

It will also be appreciated that while illustrative examples in this disclosure refer to a pharmacy associated with the pharmacy computer, there may be any number of pharmacies. In one aspect, the pharmacies may be contracted pharmacies operating under a contractual basis with the covered entity. In another aspect, the contracted pharmacies may be affiliated with each other. In certain example embodiments, affiliated and contracted pharmacies may share a common pharmacy computer or have multiple pharmacy computers associated with each pharmacy that are communicably coupled to each other and can thereby share patient and clinical information with each other.

The service provider computer 104 may include, but is not limited to, any processor-driven device that is configured for receiving, processing, and fulfilling transaction requests from the covered entity computer 102, pharmacy computer 103, the clinical module/computer 108, and/or claims processor computer 106, relating to prescription, pharmacy, benefits, and/or claim transactions or other activities. According to an example embodiment of the disclosure, the service provider computer 104 may include, but is not limited, to one or more “switches” or “switch providers” performing routing and processing of healthcare transactions between covered entities/healthcare providers, pharmacies, payors/claims processors, financial institutions, and/or other service providers. The service provider computer 104 may be any processor-driven device including, but not limited to, a server computer, a mainframe computer, one or more networked computers, a desktop computer, a personal computer, a laptop computer, a mobile computer, a handheld portable computer, a digital assistant, a personal digital assistant, a digital tablet, an Internet appliance, or any other processor-based device.

The service provider computer 104 may include a processor 126, a memory 128, input/output (“I/O”) interface(s) 130, and a network interface 132. The memory 128 may be any computer-readable medium, coupled to the processor 126, such as RAM, ROM, and/or a removable storage device for storing data files 134 and a database management system (“DBMS”) 138 to facilitate management of data files 134 and other data stored in the memory 128 and/or stored in one or more databases 182. The memory 128 may store data files 134 and various program modules, such as an operating system (“OS”) 136, a database management system (“DBMS”) 138, and the host module 140. The OS 136 may be any currently existing or future-developed operating system including, but not limited to, Microsoft Windows®, Apple OSX™, Unix, or Linux.

The data files 134 may also store routing tables for determining the destination of communications received from the covered entity computer 102, pharmacy computer 103, clinical module/computer 108, and/or claims processor computer 106. The host module 140 may receive, process, and respond to requests from the respective client modules 122, 152 of the covered entity computer 102 or pharmacy computer 103, and may further receive, process, and respond to requests from the host module 172 of the claims processor computer 106 and the clinical module/computer 108.

The database 182 may be one or more databases operable for storing information including, but not limited to, information associated with ADT transactions and healthcare transactions as well as correlation tables for diagnoses of patients (by diagnosis code) to one or more medications or combinations of medication used to treat the diagnosed malady (by medication identifier (e.g., National Drug Code (NDC) number)), as described herein.

A qualifying program eligibility verification module 109 may also be operative with the service provider computer 104. The qualifying program eligibility verification module 109 may include computer-executable instructions for performing eligibility determination for contracted pharmacies, patients, and prescribers as described herein. In general, the qualifying program eligibility verification module 109 may be operative to perform a verification of a healthcare transaction (e.g., an eligibility verification request, predetermination of benefits transaction, healthcare claim transaction, prescription claim or billing request, healthcare order transaction, or e-prescription transaction (i.e., electronic prescription order transaction, e-script, or e-prescription)) generated in response to a prescription presented to it from the pharmacy computer 103 to determine if the medication identified in the healthcare transaction is eligible under a qualifying program, such as a 340B program. The qualifying program eligibility verification module 109 may be operative to compare at least one of covered entity, patient, or prescriber information received by the service provider computer 104 to prescription information in a received healthcare transaction to make the determination. The determination may be implied by allowing the healthcare claim transaction to proceed to the claims processor computer 106 or denied by delivering a rejection of the healthcare claim transaction to the pharmacy computer 103. In certain example embodiments, the qualifying program eligibility verification module 109 may be implemented as part of the memory 128 of the service provider computer 104. Alternatively, the qualifying program eligibility verification module 109 may be implemented as computer-executable instructions of a memory of a separate processor-based system, according to an example embodiment of the disclosure. It will be appreciated that while the service provider computer 104 has been illustrated as a single computer or processor, the service provider 104 may be comprised of a group of computers or processors, according to certain example embodiments of the disclosure.

A clinical module/computer 108 may also be separate and distinct from or operative with the service provider computer 104. The clinical module/computer 108 may include computer-executable instructions for receiving healthcare transactions covering patient visit information at the covered entity (e.g., ADT transactions) from one or multiple covered entities associated with one or multiple covered entity computers 102. Each of these healthcare transactions may include one or more diagnosis codes identifying or otherwise representing maladies/illnesses being suffered by the patient, as determined by a prescriber associated with the covered entity computer 102. The clinical module/computer 108 may map the received diagnosis code in the received healthcare transaction (e.g., an ADT transaction) into a predetermined field of the transaction and can transmit the transaction on to the service provider computer 104. Thus, the clinical module/computer 108 can conform multiple types and forms of transactions from multiple distinct covered entity computers 102 so that diagnosis code information is presented in a form an location expected by the service provider computer 104. In certain example embodiments, the clinical module/computer 108 may be implemented as part of the memory 128 of the service provider computer 104. Alternatively, the clinical module/computer 108 may be implemented as computer-executable instructions of a memory of a separate processor-based system, according to an example embodiment of the disclosure.

The claims processor computer 106 may be any processor-driven device, such as, but not limited to, a server computer, a mainframe computer, one or more networked computers, a desktop computer, a personal computer, a laptop computer, a mobile computer, a handheld portable computer, a digital assistant, a personal digital assistant, a digital tablet, an Internet appliance, or any other processor-based device. The claims processor computer 106 may include a processor 158, a memory 160, input/output (“I/O”) interface(s) 162, and a network interface 164. The memory 160 may be any computer-readable medium, coupled to the processor 158, such as RAM, ROM, and/or a removable storage device for storing data files 166 and a database management system (“DBMS”) to facilitate management of data files 166 and other data stored in the memory 160 and/or stored in separate databases. The memory 160 may store data files 166 and various program modules, such as an operating system (“OS”) 168, a database management system (“DBMS”), and a host module 172. The OS 168 may be any currently existing or future-developed operating system including, but not limited to, Microsoft Windows®, Apple OSX™, Unix, or Linux. The host module 172 may receive, process, and respond to requests from the client module 140 of service provider computer 104. According to an example embodiment of the disclosure, the claims processor computer 106 may be associated with benefits determination by a healthcare insurance company, a pharmacy benefits manager (PBM), a government healthcare payor, or another third-party payor or be a collection point for cash prescription data. According to an alternative example embodiment of the disclosure, a claims processor computer 106 may also be implemented as part of the service provider computer 104.

Still referring to the claims processor computer 106, the I/O interface(s) 162 may facilitate communication between the processor 158 and various I/O devices, such as a keyboard, mouse, printer, microphone, speaker, monitor, bar code readers/scanners, RFID readers, and the like. The network interface 164 may take any of a number of forms, such as a network interface card, a modem, a wireless network card, and the like. It will be appreciated that while the claims processor computer 106 has been illustrated as a single computer or processor, the claims processor computer 106 may be comprised of a group of computers or processors, according to another example embodiment of the disclosure.

The network 110 may include any telecommunication and/or data network, whether public, private, or a combination thereof, including a local area network, a wide area network, an intranet, an internet, the Internet, intermediate hand-held data transfer devices, a publicly switched telephone network (PSTN), and/or any combination thereof and may be wired and/or wireless. The network 110 may also allow for real-time, off-line, and/or batch transactions to be transmitted between or among the covered entity computer 102, the pharmacy computer 103, the service provider computer 104, the clinical module/computer 108, and/or the claims processor computer 106. Due to network connectivity, various methodologies as described herein may be practiced in the context of distributed computing environments. It will also be appreciated that the network 110 may include a plurality of networks, each with devices such as gateways and routers for providing connectivity between or among networks 110. Instead of or in addition to a network 110, dedicated communication links may be used to connect the various devices in accordance with an example embodiment of the invention. For example, the service provider computer 104 may form the basis of a network 110 that interconnects the covered entity computer 102 with the pharmacy computer 103, or that interconnects the pharmacy computer 103 with the claims processor computer 106.

Generally, each of the memories and data storage devices, such as the memories 112, 142, 128, 160 and the database 182, and/or any other memory and data storage device, can store data and information for subsequent retrieval. In this manner, the system 100 can store various received or collected information in memory or a database associated with one or more covered entity computers 102, pharmacy computers 103, service provider computer 104, and/or claims processor computers 106. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices. In one example embodiment, for security, the service provider computer 104 (or any other entity) may have a dedicated connection to the database 182, as shown; though, in other embodiments, the service provider computer 104 or another entity may communicate with the database 182 via the network 110.

Suitable processors, such as the processors 119, 149, 126, 158 of the covered entity computers 102, pharmacy computers 103, service provider computer 104, and/or claims processor computers 106, respectively, may comprise a microprocessor, an ASIC, and/or a state machine. Example processors can be those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript. Furthermore, any of the processors may operate any operating system capable of supporting locally executed applications, client-server based applications, and/or browser or browser-enabled applications.

The system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. For example, in one example embodiment, the service provider computer 104 (or the covered entity computer 102/claims processor computer 106/clinical module/computer 108) may be implemented as a specialized processing machine that includes hardware and/or software for performing the methods described herein. Accordingly, embodiments of the disclosure should not be construed as being limited to any particular operating environment, system architecture, or device configuration.

Operational Overview

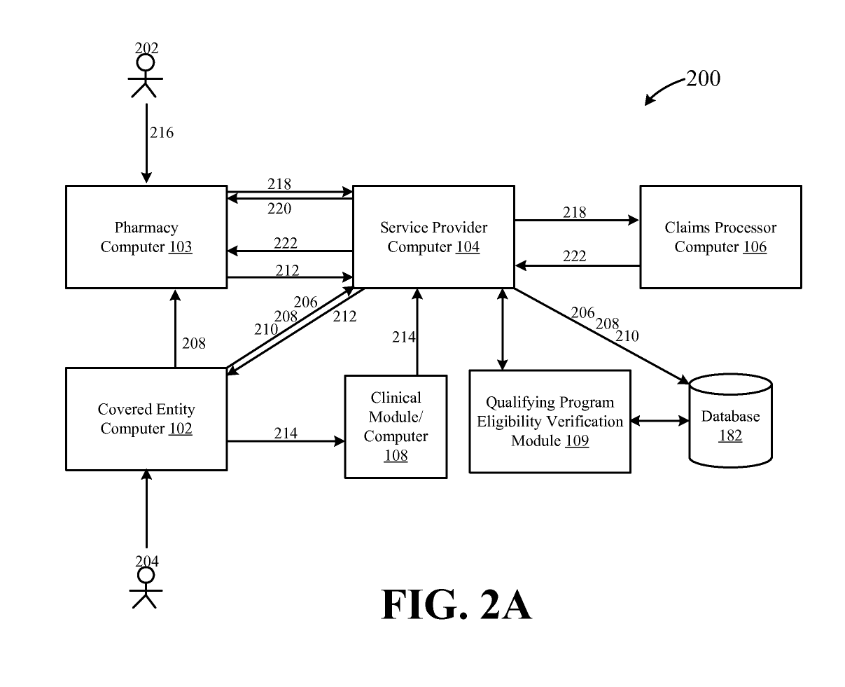

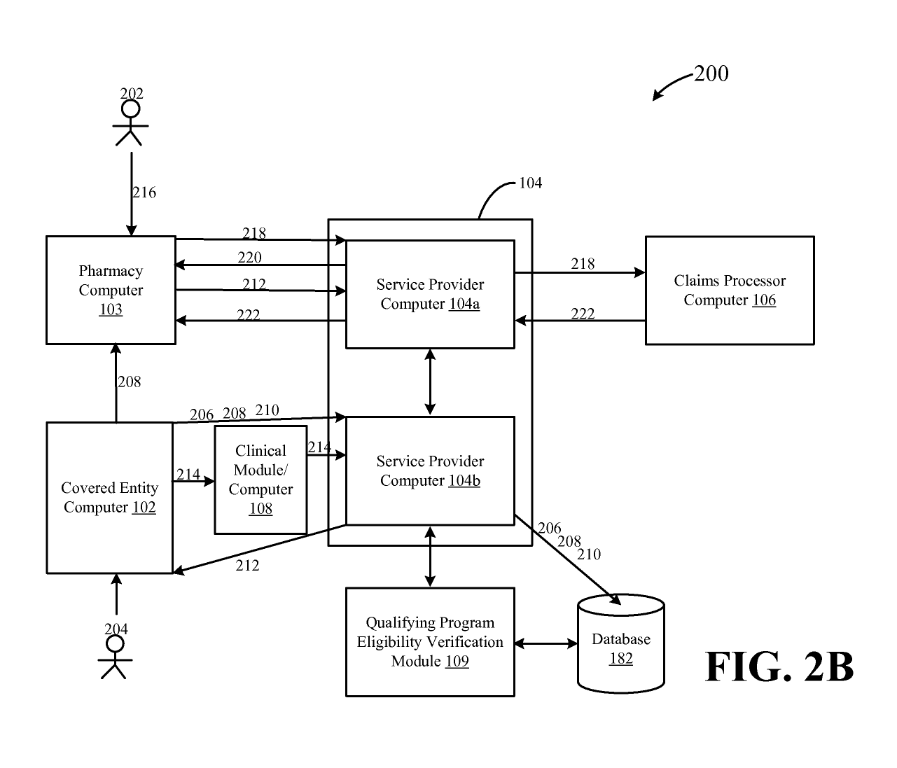

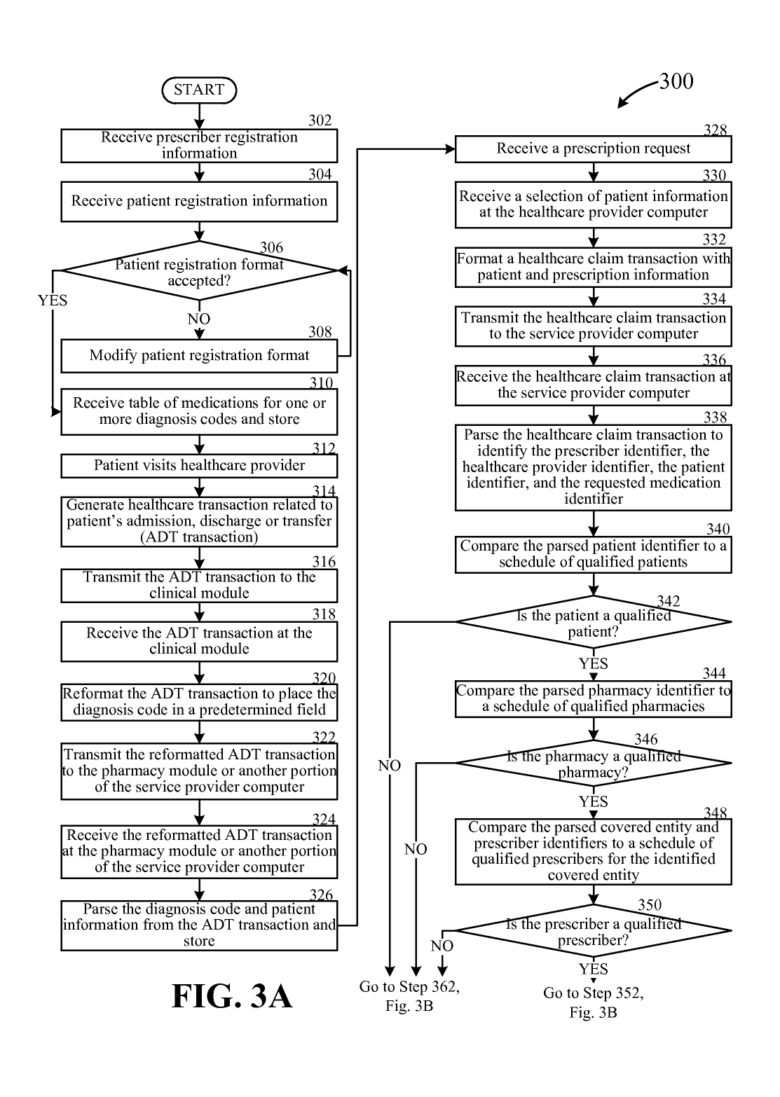

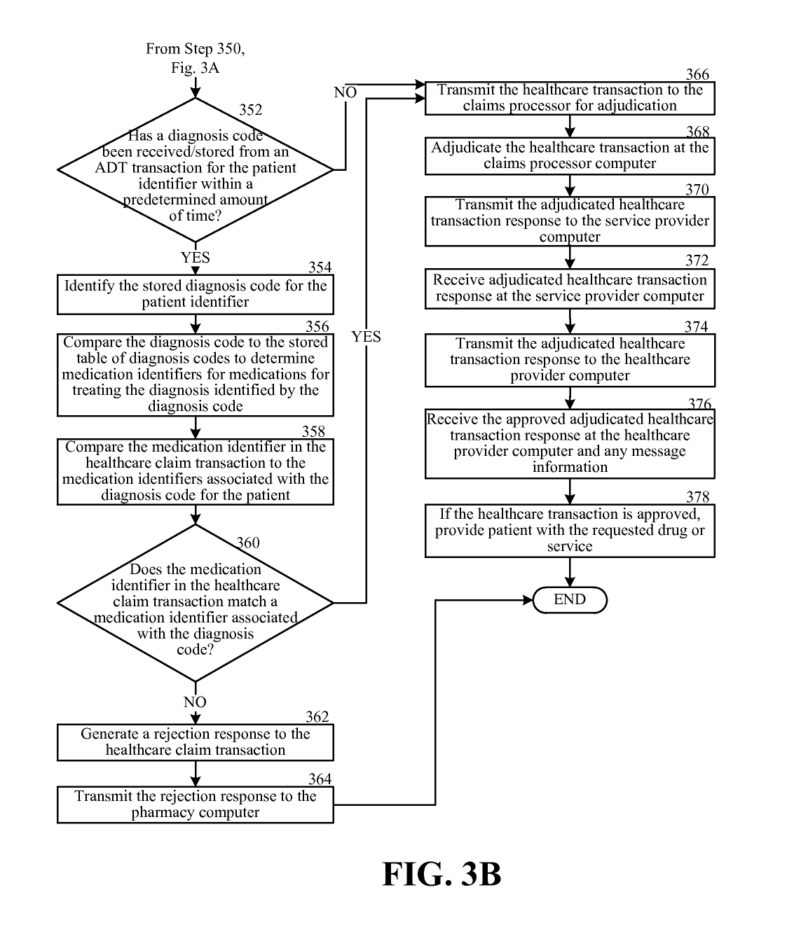

FIG. 2A is a diagram of one example data flow 200 for verifying correlation of diagnosis and medication as part of a qualifying program eligibility verification of a healthcare transaction processed through a service provider computer, such as through the service provider computer 104 illustrated in FIG. 1. FIGS. 3A-3B are flow charts of an example method 300 for verifying correlation of diagnosis and medication as part of a qualifying program eligibility verification of a healthcare transaction through a service provider computer, in accordance with one exemplary embodiment. All or a portion of the steps in the exemplary method 300, described below, may be performed by a suitable service provider computer 104 and/or clinical module/computer 108. The exemplary method 300 will be described with reference to a covered entity healthcare provider as the covered entity; however, this is only for purposes of example as other specific covered entities (and corresponding covered entity computers 102) including, but not limited to, a federally-qualified health center as defined in (see, e.g., 1905(I)(2)(B) of the Social Security Act (SSA)), a family planning entity, a State-operated AIDS Drug Assistance Program, a disproportionate share hospital as defined in (see, e.g., section 1886(d)(1)(B) of the SSA), a hospital, a clinic, a hospice, a doctor's office, a primary care center, a senior care center, a chain of affiliated hospitals, a community health center, a university teaching hospital, or combinations thereof, could be substituted for, and should each be individually read as being a part of each of these methods. In one aspect, the covered entity may qualify for providing prescriptions under a predetermined qualifying program. For example, certain hospitals may be designated as 340B program eligible qualifying healthcare provider and, therefore, prescriptions generated by those hospitals may qualify under the terms of the 340B program. As such, where the discussion of the methods below and the drawings state a covered entity healthcare provider, any other specific covered entity (and associated covered entity computer 102) could be substituted.

In addition, the exemplary method 300 will be described with reference to an ADT transaction transmitted by a covered entity computer 102; however, this also is only for purposes of example as other electronically transmitted healthcare transactions that provide diagnosis information (e.g., via diagnosis code) for a patient could be substituted for the ADT transaction and each form of these electronically transmitted healthcare transactions should each individually be read as being used in the method described below.

The following descriptions will describe the transmission of information between one or more entities, including the covered entity computer 102 associated and/or located within with one or more covered entities, the pharmacy computer 103 associated with (i.e., located within) one or more pharmacies, the service provider 104, the claims processor 106, the clinical module/computer 108, a patient 202, and a prescriber 204 to provide patient and/or clinical information to the service provider 104, the clinical module/computer 108, and/or the pharmacy computer 103. As described herein, the covered entity healthcare provider or the patient 202 may be eligible for discounted prescription drugs or products from a pharmaceutical manufacturer or distributor, perhaps in accordance with a 340B program.

The prescriber 204, as used herein, may include any suitable entity that can legally generate a prescription, including, but not limited to, a doctor, a nurse, a registered nurse, a physician, a physician's assistant, another person legally permitted to write prescriptions for medications, or combinations thereof. The prescriber 204 may diagnose a malady for the patient 202 and prescribe a prescription drug or product for the patient 202. In certain aspects, the service provider computer 104 may utilize patient and/or clinical information presented to it for the purposes of determining if a particular prescription presented to the pharmacy associated with the pharmacy computer 103 includes a prescribed medication typically used to treat the malady identified by the diagnosis code received by the service provider computer 104 for the patient and if the prescription (and the prescribed medication identified therein) qualifies under the predefined qualifying program and is eligible for the terms associated with the same.

The prescription, as used herein, may pertain to an order by a prescriber to instruct the pharmacy associated with the pharmacy computer 103 to dispense an associated product to the patient 202. The prescription order may be delivered by the patient to the pharmacy on paper. Alternatively, the prescription order may be delivered to the pharmacy via mail, telephone order, facsimile or e-prescribed by the prescriber. In one example, the prescription may be associated with a single patient. Furthermore, the prescription may be associated with either a single product or multiple products.

The product associated with the prescription may include, but is not limited to, a medication, a pharmaceutical, a narcotic, a controlled substance, a medical device, vitamins, a prescription drug, an over-the-counter drug, or combinations thereof. In one example, when a prescription is filled, the pharmacy may provide or disburse the associated product to the patient 202. The pharmacy, via the pharmacy computer 103, may further report the disbursement of the product associated with the prescription to one or more of the covered entity computer 102, the service provider computer 104, the claims processor computer 106, the prescriber 204, or the patient 202 for the purposes of recordkeeping, auditing, billing, qualifying program eligibility verification, or combinations thereof.

The predefined qualifying program may be any suitable program, including, but not limited to the federal 340B program, section 602 pricing, group purchasing organizations (GPO) program, patient assistance program (PAP), Medicare, Medicaid, or combinations thereof. One particular predefined qualifying program, the 340B program, was established by Section 602 of the Veterans Healthcare Act of 1992 (P. L. 102-585), which put Section 340B of the Public Health Service Act into place. Sometimes referred to as “PHS Pricing” or “602 Pricing,” the 340B Drug Pricing Program requires drug manufacturers to provide outpatient drugs to certain covered entities specified in the statute 42 U.S.C. 340B(a)(4) at a reduced price, also defined in the statute. These covered entities are Health Resources and Service Administration (HRSA) grantees, Federally Qualified Health Centers (FQHCs) and FQHC look-alikes, family planning clinics, HIV/Ryan White clinics, state-operated AIDS drug assistance programs, black lung clinics, hemophilia treatment centers, urban Indian organizations, Native Hawaiian health centers, sexually transmitted disease and tuberculosis clinics, and disproportionate share hospitals. In addition, Children's Hospitals were added to the program as a provision of the Social Security Act (SSA) amended by the Deficit Reduction Act. Section 7101 of the Affordable Care Act (ACA) expanded the definition of covered entities that are now eligible to participate. These covered entities include: Critical Access Hospitals, Free Standing Cancer Hospitals, Rural Referral Centers, and Sole Community Hospitals. The program is administered by the Office of Pharmacy Affairs (OPA) of HRSA, under the federal Department of Health and Human Services (HHS).

The 340B price defined in the statute is a ceiling price, meaning it is the highest price a covered entity healthcare provider would have to pay for a given outpatient drug. Covered entity healthcare providers can negotiate below ceiling prices with manufacturers and/or marketers of products. As a result, 340B prices for product have been found to be roughly 50% of the Average Wholesale Price (AWP) for those same products outside of the 340B program.

The 340B Program does not have any income requirements for patients 202. Any patient 202 of a participating 340B covered entity healthcare provider is considered a 340B patient provided the covered entity healthcare provider maintains control of the patient's medical records. Therefore, a pharmacy receiving a prescription from a patient may need to verify if the prescription is eligible for the 340B program. In one example, the verification may entail determining if the prescription is associated with the covered entity healthcare provider, where the covered entity healthcare provider qualifies as a participating 340B covered entity healthcare provider. For example, verification may include determining if the patient 202 associated with the prescription is affiliated with, or otherwise receiving medical services from the participating 340B covered entity healthcare provider. In addition, verification may include determining if the product identified in the prescription is one that is typically used to treat the malady currently affecting the patient 202. Furthermore, verification may include determining if the prescriber 204 that generated or authorized the prescription is affiliated with, or otherwise providing medical services as an agent of the participating 340B covered entity healthcare provider.

Referring now to FIGS. 1, 2A, 3A, and 3B the exemplary method 300 begins at the START step and proceeds to step 302, where prescriber registration information 206 is received at the service provider computer 104. In one example, the prescriber registration information 206 may be received by the service provider computer 104 from the covered entity computer 102 via, for example, the network 110. In certain example embodiments, the prescriber registration information 206 may pertain to a specific prescriber of the prescription. For example, the prescriber registration 206, and the information contained therein may be utilized by the service provider computer 104 to determine if a particular prescriber 204 is affiliated with the covered entity healthcare provider. The service provider 104 may store the prescriber registration information 206 in the database 182. In certain example embodiments, the prescriber registration information 206 may be stored to a particular repository or section of the database 182 that is associated with the particular respective covered entity. The prescriber information included in the prescriber registration information 206 may include, but is not limited to, prescriber identification (e.g., prescriber's last name, NPI number, Drug Enforcement Agency (DEA) number). In certain example embodiments, the prescriber registration may notify the service provider computer 104 of a new prescriber affiliated with the covered entity and store the same to the database 182. In certain other example embodiments, the prescriber registration may notify the service provider computer 104 of updated information associated with a pre-existing prescriber affiliated with the covered entity and the service provider computer 104 may update the database 182 with the same.

In certain example embodiments, the prescriber registration information 206 may be delivered to the service provider computer 104 from the covered entity computer 102 in a batch fashion, where multiple prescriber registrations are transmitted via communicative pathway at substantially the same time. In one example, prescriber registrations communicated in a batch fashion may be transmitted periodically, such as, for example, daily, weekly, or monthly. In certain other example embodiments, the prescriber registration information 206 may be delivered to the service provider computer 104 from the covered entity computer 102 in a sequential fashion via the communicative pathway.

In one example embodiment, the prescriber registration information 206 may be delivered in a format, such as an electronic format with a particular sequence and delimitation of information that is agreed upon between the covered entity computer 102 and the service provider computer 104. In certain example embodiments, transmission of the prescriber registration information 206 may be a secure or encrypted transmission, such as via a secure file transfer protocol (SFTP). In other example embodiments, the service provider computer 104 may provide acknowledgment to the covered entity computer 102 after receiving the prescriber registration information 206 that the prescriber registration information 206 has been successfully received.

In step 304, the covered entity computer 102 may provide patient registration information 208 and patient encounter information 210 to the service provider computer 104. The patient registration file 208 may be communicated from the covered entity computer 102 to the service provider computer 104 via the network 110. The patient registration file 208 may have any suitable format and patient related information contained therein. In certain example embodiments, the patient registration file 208 may be an electronic file. In alternative example embodiments, the patient registration file 208 may include a hardcopy that may be provided to the service provider computer 204 by any variety of mechanisms.

In certain example embodiments, receipt of the patient registration file 208 may notify the service provider computer 104 of a new patient affiliated with (e.g., under the care of) the covered entity and covered entity computer 102 and store the same to the database 182. In other example embodiments, receipt of the patient registration file 208 may notify the service provider computer 104 of updated information associated with a pre-existing patient affiliated with (e.g., under the care of) the covered entity and the covered entity computer 102, and the service provider computer 104 may update the database 182 with the same. In certain example embodiments transmission of the patient registration information 208 may be a secure or encrypted transmission, such as via SFTP.

In certain example embodiments, the patient registration information 208 may be delivered in any suitable format, such as an electronic format with a particular sequence and delimitation of information that is agreed upon between the covered entity computer 102 and the service provider computer 104. For example, the patient registration information 208 may be sent in accordance with the Health Level Seven International (HL7) communications and interoperability standards. In this example, an HL7 code “A08” may be sent indicative of updating patient information with the service provider computer 104 and an HL7 code “A28” may be sent to establish a new patient record or add patient information. Therefore, the service provider computer 104 and the covered entity computer 102 may communicate with each other with a common set of communicative standards. In other example embodiments, the service provider computer 104 and the covered entity computer 102 may communicate with each other using a dissimilar set of communicative standards. In one example, there may be mechanisms for translating between various communicative standards.

As a further example, the following information and file format may be included in a patient registration 208:
Header (HDR)
   i. Name: Patient Registration File
   ii. Healthcare System ID: [XXXXXXXXXX] (10 characters)
   iii. Healthcare System: [XXXXXXXXXX] (30 characters)
   iv. Date/Time: MMddccyyHHmmss
Detail (DTL)
   i. Patient First Name
   ii. Patient Last Name
   iii. Patient Medical Record Number
   iv. Patient Street Address
   v. Patient City Address
   vi. Patient State Address
   vii. Patient ZIP/Postal Zone
   viii. Date of Birth
   ix. Encounter Date (MMDDCCYY)
   x. Encounter Service Location
Trailer (TRL)
   xi. Record Count: NNN,NNN

It can be seen from this example, that the patient registration information 208 may contain information that identifies the patient (e.g., all of the information elements in the DTL) and the covered entity (e.g., Healthcare System ID and Healthcare System). Therefore, the patient registration information 208 may provide information related to the covered entity associated with (e.g., providing care to) the patient.

In certain example embodiments, in addition to patient registration information 208, a patient encounter message 210 may be transmitted by the covered entity computer 102 to the service provider computer 104 via, for example, the network 110. The patient encounter information 210 may include, for example, Admit/Visit Notification (HL7 code=A01) information that may be provided if a patient has been seen (e.g., evaluated or diagnosed) or treated at the covered entity facility associated with the covered entity computer 102 or Register a Patient (HL7=A04) that may be provided if a patient has been admitted to the covered entity facility overnight.

It will be appreciated that patient encounter information in conjunction with patient registration information may be indicative of patient association with a particular covered entity. In other words, the patient encounter information may indicate that the patient 202 has not only registered with a particular covered entity, but that the patient may also be receiving services from the covered entity. Therefore, in situations where the patient 202 is registered with more than one covered entity, the service provider computer 104 may determine that that patient 202 may be receiving healthcare service from a particular covered entity associated with a particular covered entity computer 102 based upon the patient encounter information 210. It will be appreciated that in certain example embodiments, the patient encounter information 210 may not be transmitted by the covered entity computer 102 to the service provider computer 104.

Once the patient registration information 208 is received by the service provider computer 104, the registration information 208 may be further forwarded to the pharmacy computer 103 via, for example, the network 110. The pharmacy computer 103 at that point may verify that the patient registration information 208 has been received and that the patient registration information 208 is complete and provide an indication of the same to the service provider computer 104 via, for example, the network 110.

In step 306, an inquiry is conducted to determine if the patient registration information is in the proper format and has been accepted by the pharmacy computer 103. In certain example embodiments, the determination can be made by the client module 152 or another portion of the pharmacy computer 103. For example, a patient registration response 212 may be generated by the client module 152 of the pharmacy computer 103 and transmitted from the pharmacy computer 103 via the service provider computer 104, to the covered entity computer 102. For example, the patient registration response 212 may indicate if the patient registration information 208 has been received and accepted by the pharmacy associated with the pharmacy computer 103. In one example, the indication of acceptance may be an acknowledgment of acceptance. Alternatively, the indication of acceptance may be a negative acknowledgment, where a non-acceptance of the patient registration information 208 is communicated by the pharmacy computer 103 to the service provider computer 104, and then, from the service provider computer 104 to the covered entity computer 102. In certain embodiments, the acceptance of the patient registration may indicate that the format of the patient registration information 208 contained in the patient registration is properly formatted. In other example embodiments, the acceptance of the patient registration may indicate that the format of the patient registration information 208 contained in the patient registration is relatively complete. If the patient registration format has been accepted by the pharmacy computer 103, then the YES branch is followed to step 310. Otherwise, the NO branch is followed to step 308.

In step 308, the patient registration format may be modified. The modification may entail repairing any deficiencies in the patient registration, such as providing any missing information that may be requested by the pharmacy computer 103. The modification may further entail changing the order of the information contained in the patient registration. The modification may further involve requesting additional information from the patient 202 and updating the patient registration with the same. The method may then return to block 304 and provide the modified patient registration to the service provider computer 104. In step 310, the service provider computer 104 can receive a correlation table of medications and diagnosis codes from the pharmacy computer 103, the covered entity computer 102 or another third-party computer. For example, the pharmacy computer 103 may also utilize the client module 152 to retrieve industry standard diagnosis codes and the medications (e.g., by a medication identifier such as NDC code or RxNorm code) typically used to treat the malady identified by the diagnosis code, correlate each diagnosis code to the one or more medication identifiers identifying medication used to treat the malady identified by the diagnosis code, and transmit the correlation of diagnosis code and medication identifiers to the service provider computer 104 via the network 110.

In step 310, a patient 202 visits a healthcare provider. In one example embodiment, the healthcare provider is a covered entity associated with the covered entity computer 102. In step 314, the covered entity, via the covered entity computer 102, can generated a healthcare transaction related to the patient's visit. In one example, embodiment, the healthcare transaction is an ADT transaction 214. The covered entity computer 102 can transmit the ADT transaction 214 to the clinical module/computer 108 via, for example, the network 110 in step 316. In an alternate example embodiment, the covered entity computer 102 can transmit the ADT transaction 214 to the service provider computer 104 via the network 110. The clinical module/computer 108 receives the ADT transaction 214 in step 318.

In step 320, the clinical module/computer 108 can reformat the ADT transaction 214 to place a diagnosis code within the ADT transaction 214 into a predetermined field of the ADT transaction 214. For example, different covered entity computers may place the diagnosis code in different places or in a different format in the healthcare transaction (e.g., the ADT transaction). As such, to make information consistent, the clinical module/computer 108 may receive the ADT transaction 214, identify the diagnosis code and then reformat or otherwise modify the form or placement of the diagnosis code with the ADT transaction 214 so that it is consistent with other healthcare transactions, such as other ADT transactions, passed on by the clinical module/computer 108 to the service provider computer 104. In situations where the diagnosis code in the ADT transaction 214 is properly formatted and placed, no action may be taken on that particular transaction. In step 322, the clinical module/computer 108 can transmit the reformatted ADT transaction 214 to the pharmacy module 139 or another portion of the service provider computer 104. In example embodiments where the clinical module 108 is part of the service provider computer 104, this transmission may be internal to the service provider computer or not done at all.

In step 324, the service provider computer 104 can receive the reformatted ADT transaction at, for example, the pharmacy module 139. In step 326, the pharmacy module 139 or another portion of the service provider computer 104 can parse the ADT transaction 214 to identify the diagnosis code and one or more patient identifiers (e.g., patient first name, patient last name, patient address, patient zip/postal code, patient health insurance claim number (HICN), patient social security number, etc.) in the ADT transaction 214 and can store those in, for example, the database 182 or the data files 134. In addition, the service provider computer can parse the transaction 214 to identify a time/date of service for the ADT transaction 214 and can also store that information the database 182 or data files 134. In this way, the service provider computer 104 can associate a patient 202 with a diagnosis, via the diagnosis code and the time/date the diagnosis was received from a covered entity.

In step 328, a prescription/order request 216 is received. In one example embodiment, the prescription/order request 216 is received by a pharmacist at a pharmacy. The prescription/order request 216 may be received from a patient 202, another healthcare provider prescribing a medication or service (e.g., physician, hospital, etc.), by phone, via the Internet, via an electronic prescription (e.g., via the covered entity computer 102), or by way of an electronic system order. For example, the prescription 216 may be received by the patient 202 from a prescriber of the medication at a covered entity. The patient 202 may go to the location of the pharmacy and physically hand the prescription request 216 to the pharmacist or make a request via a web portal communicably coupled to the pharmacy computer 103 or an IVR communicably coupled or otherwise providing order data to the pharmacy computer 103. The pharmacist determines the patient's name and accesses the pharmacy computer 103, which receives a selection of patient information from the pharmacist via the I/O interface 154 in step 330. For example, the pharmacist accesses the pharmacy computer 103 and accesses a database of patient information, which may be stored in memory 142 or in another database either local or remote from the pharmacy computer 103. The pharmacist can then select the name or other patient identification information in the patient information database that matches the name or other identification information of the patient 202.

In step 332, a second healthcare transaction 218 (e.g., an eligibility verification request, predetermination of benefits transaction, healthcare claim transaction, prescription claim or billing request, healthcare order transaction, or e-prescription transaction (i.e., electronic prescription order transaction, e-script, or e-prescription)) is generated and/or formatted at the pharmacy computer 103. While the exemplary method 300 will describe the second healthcare transaction with reference to a healthcare claim transaction, this also is only for purposes of example as other healthcare transactions, which may include, for example, a predetermination of benefits transaction, the healthcare claim transaction, prescription claim or billing request, healthcare order transaction, or e-prescription transaction (i.e., electronic prescription order transaction, e-script, or e-prescription) could be substituted for the healthcare claim transaction and each form of second healthcare transaction should each individually be read as being used in the method 300.

In certain exemplary embodiments, the pharmacy computer 103 formats the healthcare claim transaction 218 with patient information, Payor ID/routing information, and medication information. The information can be input into the healthcare claim transaction 218 by the pharmacist via the I/O interface 154 or automatically retrieved and entered by the pharmacy computer 103 based at least in part on historical transaction information for the patient in the data files 158 or a database communicably coupled to the pharmacy computer 103. According to one example embodiment, the healthcare claim transaction 218 may be formatted in accordance with a version of the National Council for Prescription Drug Programs (NCPDP) Telecommunication Standard, although other standards may be utilized as well.

As discussed above, the healthcare claim transaction 218 may include a Banking Identification Number (BIN) Number, a BIN Number and Processor Control Number (PCN), and/or a BIN Number and Group ID for identifying a particular claims processor computer (i.e., PBM, payor, healthcare insurance company, Medicare or other government healthcare insurance payor, Medicare Part D provider, etc.), such as the claims processor computer 106, as a destination for the healthcare claim transaction 218. In addition, first healthcare claim transaction 218 may also include information relating to the patient, payor, prescriber, healthcare provider (e.g., potentially a covered entity), and/or the requested medication. As an example, the healthcare claim transaction 218 may include one or more of the following information:

Payor ID/Routing Information
BIN Number, BIN Number and PCN and/or BIN Number and Group ID, that designates a destination of the healthcare claim transaction 218

Patient Information
Name (e.g. Patient Last Name, Patient First Name, etc.)
Date of Birth of Patient
Age of Patient
Gender
Patient Address (e.g. Street Address, Zip Code, etc.)
Patient Contact Information (e.g. patient telephone number, email address, etc.)
Patient Health Condition Information
Patient ID or other identifier (e.g., Health Insurance Claim Number (HICN), social security number, etc.)

Insurance/Coverage Information
Cardholder Name (e.g. Cardholder First Name, Cardholder Last Name)
Cardholder ID and/or other identifier (e.g. person code)
Group ID and/or Group Information

Prescriber Information
Covered Entity ID or other identifier (e.g. NPI code)
Covered Entity Name (e.g. Last Name, First Name)
Prescriber ID or other identifier (e.g. NPI code, DEA number)
Prescriber Name (e.g. Last Name, First Name)
Prescriber Contact Information (e.g. Telephone Number)
Pharmacy or other Healthcare Provider Information (e.g. store name, chain identifier, etc.)
Pharmacy or other Healthcare Provider ID (e.g. NPI code)

Claim Information
Drug, service, or product information (e.g. National Drug Code (NDC) code, RxNorm code, etc.)
Prescription/Service Reference Number
Date Prescription Written
Quantity Dispensed
Days' Supply
Diagnosis/Condition (e.g., diagnosis code)
Pricing information for the drug/service/product (e.g. network price, Usual & Customary price)
Number of Refills Authorized
One or more NCPDP Message Fields
One or more Drug Utilization (DUR) Codes
Date of Service.

The healthcare claim transaction 218 can be used to determine if the claims processor associated with the claims processor computer 106 approves or rejects payment coverage for medication being requested in the healthcare claim transaction 218 and, if approved, the amount the claims processor will cover (or pay) for the medication being requested and how much the patient co-pay amount will be.

The pharmacy computer 103 transmits the healthcare claim transaction 218 to the service provider computer 104 in step 334. In step 336, the service provider computer 104 receives the healthcare claim transaction 218. For example, the healthcare claim transaction 218 can be transmitted by the pharmacy computer 103 to the service provider computer 104 through the network 110. In step 338, the service provider computer 104, such as the pharmacy module 139 or another portion of the service provider computer 104, parses the healthcare claim transaction 218 to identify, for example, the prescriber identifier, the healthcare provider identifier, one or more patient identifiers, and the medication identifier. In certain example embodiments, the service provider computer 104 may be configured to determine entities associated with the prescription and make a determination of eligibility of the prescription under one or more predefined qualifying plans based thereon.

In certain example embodiments, steps 338-360 present an example method of determining if a prescription for a medication requested in the healthcare claim transaction 218 is eligible under a qualifying program. The eligibility may be determined by the service provider computer 104 based on information in the healthcare claim transaction and/or information received by the service provider computer 104 from one or more of the covered entity (e.g., via the covered entity computer 102), pharmacy (e.g., via the pharmacy computer 103), patient 202, or the prescriber 204 (e.g., via the covered entity computer 102). In certain embodiments, the service provider computer 104 in conjunction with the qualifying program eligibility verification module 109 may determine if a particular prescription qualifies under one or more qualifying programs. In one aspect, the eligibility may be determined by the service provider computer 104 in conjunction with the qualifying program eligibility verification module 109 based at least in part on the information contained in the healthcare claim transaction 218. In another aspect, the eligibility may be determined by the service provider computer 104 in conjunction with the qualifying program eligibility verification module 109 based at least in part on one or more of the prescriber registration 206 or the patient registration 208. In a further aspect, the eligibility under a qualifying program may be determined based at least in part on the patient encounter information 210. In certain embodiments, the service provider computer 104 and/or the qualifying program eligibility verification module 109 may compare particular information elements contained in the healthcare claim transaction 218 with corresponding information elements in the prescriber registration 206 and/or the patient registration 208 and/or the patient encounter information 210.

In step 338, the service provider computer 104, such as the qualifying programs eligibility verification module 109 or another portion of the service provider computer 104, parses the healthcare claim transaction 218 to identify, for example, the prescriber identifier, the covered entity identifier, one or more patient identifiers, and the medication identifier. In certain example embodiments, the service provider computer 104 may be configured to determine entities associated with the prescription and make a determination of eligibility of the prescription under one or more predefined qualifying plans based thereon. In step 340, the qualifying programs eligibility verification module 109 or another portion of the service provider computer 104 can compare the parsed one or more patient identifiers from the healthcare claim transaction to a schedule of qualified patients. For example, the qualifying programs eligibility verification module 109 can compare one or more of the parsed patient identifiers to a table, schedule or listing of patients qualified to receive benefits under a qualifying program, such as a 340B program, to determine if a match exists. In another example embodiment, the qualifying program eligibility verification module 109 may access the patient encounter information 210 stored in, for example, the database 182, to verify if the patient 202 identified by the one or more patient identifiers in the healthcare claim transaction 218 has received services from a covered entity.

In step 342, an inquiry is conducted to determine if the patient is a qualified patient. In certain example embodiments, the determination can be made by the qualifying program eligibility verification module 109 or another portion of the service provider computer 104. For example, if the one or more patient identifiers matches patient information stored in the table of qualified patients, then the patient 202 identified in the healthcare claim transaction 218 is a qualified patient. If the patient 202 is determined to be a qualified patient, then the YES branch is followed to step 344. Otherwise, the NO branch is followed to step 362.

In step 344, the qualifying programs eligibility verification module 109 or another portion of the service provider computer 104 can compare the parsed pharmacy identifier from the healthcare claim transaction to a schedule of qualified pharmacies to dispense medication under a qualified program, such as a 340B program. For example, the qualifying programs eligibility verification module 109 can compare the parsed pharmacy identifier (e.g., NPI code) to a table, schedule or listing of pharmacies qualified to dispense medication under a qualified program, such as a 340B program, to determine if a match exists.

In step 346, an inquiry is conducted to determine if the pharmacy is qualified to dispense medication under a qualified program, such as a 340B program. In certain example embodiments, the determination can be made by the qualifying program eligibility verification module 109, the pharmacy module 139, or another portion of the service provider computer 104. For example, if the one or more pharmacy identifiers matches one of the pharmacy identifiers stored in the table of qualified pharmacies, then the pharmacy associated with the pharmacy computer 103 and identified in the healthcare claim transaction 218 is a qualified pharmacy. If the pharmacy is determined to be a qualified pharmacy, then the YES branch is followed to step 348. Otherwise, the NO branch is followed to step 362.

In step 348, the qualifying programs eligibility verification module 109 or another portion of the service provider computer 104 can compare the parsed covered entity identifier and prescriber identifier from the healthcare claim transaction 218 to one or more tables, listings, or schedules of covered entities and prescribers qualified to prescribe medication under a qualified program, such as a 340B program. In one example embodiment, the qualifying programs eligibility verification module 109 can compare the parsed covered entity identifier (e.g., healthcare provider identifier (e.g., NPI code)) to a table, schedule, or listing of covered entities qualified to provide care and prescribe medications to patients under a qualified program, such as a 340B program, to determine if a match exists. In addition, in the example embodiment, the qualifying programs eligibility verification module 109 can compare the parsed prescriber identifier (e.g., NPI code or DEA number) to a table, schedule, or listing of prescribers qualified to provide care and prescribe medications to patients under a qualified program, such as a 340B program, to determine if a match exists. In another example, the qualifying program eligibility verification module 109 may utilize this Primary Care Provider ID field of the healthcare claim transaction 218 and compare the same to a database of registrations of one or more covered entities with the service provider computer 104, wherein the registration with the service provider computer 104 may indicate if the covered entity is eligible under a qualified program, such as a 340B program. In yet another example embodiment, the qualifying program eligibility verification module 109 may access the patient registration 208 associated with the healthcare claim transaction 218 and assess if the “Healthcare System ID” or the “Healthcare System” fields indicate a covered entity that is eligible for 340B programs. If the covered entity corresponding to the aforementioned fields of the patient registration 208 are indicative of a 340B eligible covered entity, then the qualifying program eligibility verification module 109 may determine that covered entity identified in the healthcare claim transaction 218 is a qualified covered entity.

It can be appreciated that the eligibility verification may be enabled by the covered entity computer 102 sharing patient information, patient encounter information, prescriber information, covered entity information, or clinical information with at least one of the service provider computer 104, the qualifying program eligibility verification module 109, or the pharmacy computer 103. In this case, information contained in the patient registration 208 or the prescriber registration 206 or the patient encounter information 210 may be compared, at least in part, to the information in the healthcare claim transaction 218 to make an eligibility determination.

In step 350, an inquiry is conducted to determine if the prescriber is qualified to prescribe medication as part of a covered entity under a qualified program, such as a 340B program. In certain example embodiments, the determination can be made by the qualifying program eligibility verification module 109 or another portion of the service provider computer 104. For example, if the one or more prescriber identifiers and or covered entity identifiers matches one of the prescriber identifiers and/or covered entity identifiers stored in the table of qualified prescribers, then the prescriber associated with the covered entity and identified in the healthcare claim transaction 218 is a qualified prescriber. If the prescriber is determined to be a qualified prescriber, then the YES branch is followed to step 352. Otherwise, the NO branch is followed to step 362.

In step 352, an inquiry is conducted to determine if a diagnosis code has been received and optionally stored from a healthcare transaction, such as ADT transaction 214, for the patient identified by the one or more patient identifiers from the healthcare claim transaction 218. In certain example embodiments, the inquiry can be based on if the diagnosis code via healthcare transaction was received within a predetermined amount of time. The predetermined amount of time can have a configurable range based on the desires of the user and in certain example embodiments can be any amount of time between 1 second to 365 days. For example, if the predetermined amount of time was seven days, the qualifying program eligibility verification module 109 or another portion of the service provider computer 104 can compare the one or more patient identifier parsed from the healthcare claim transaction 218 to a table, listing, or schedule of healthcare transactions, in for example, the database 182 to determine if a diagnosis code has been received for a patient having one or more matching patient identifiers. If a record having a matching one or more patient identifiers is found, the qualifying program eligibility verification module 109, for example, can determine how long ago the diagnosis was given to the patient, based, for example, a time/date of service identified in the ADT transaction 214 and stored previously. For purposes of example, if the date of service in the ADT transaction 214 was fifteen days ago, the diagnosis code associated with that transaction 214 may not be reviewed as it may be determined to be too far removed, from a time perspective, from when the prescription was presented for filling. On the other hand, if the date of service in the ADT transaction 214 was three days ago, (against a threshold of seven days), then diagnosis code may be retrieved for evaluation. If a diagnosis code is received and optionally satisfies the time threshold, the YES branch is followed to step 354. On the other hand, if a diagnosis code has not been received for the patient and/or, optionally, it does not satisfy the time threshold, the NO branch is followed to step 366.

In step 354, the qualifying program eligibility verification module 109 or another portion of the service provider computer 104 can identify the stored diagnosis for the matching patient identifier from the healthcare claim transaction 218. In step 356, the qualifying program eligibility verification module 109 or another portion of the service provider computer 104 can compare the identified diagnosis code to the stored table of diagnosis codes in, for example, the database 182 to determine the medication identifiers for medications that are typically used for treating the malady identified by the diagnosis code. The qualifying program eligibility verification module 109 or another portion of the service provider computer 104 can compare the medication identifier parsed from the healthcare claim transaction 218 to the one or more medication identifiers from step 356 that identify medications that are typically used for treating the malady identified by the diagnosis code in step 358.

In step 360, an inquiry is conducted to determine if the medication identifier in the healthcare claim 218 transaction matches one of the medications identifiers identifying a medication typically used to treat the malady identified by the diagnosis code. In certain example embodiments, the determination can be made by the qualifying program eligibility verification module 109 or another portion of the service provider computer 104. If the medication identifier matches, the YES branch is followed to step 366. Otherwise, the NO branch is followed to step 362, where the service provider computer 104 generates a rejection response 220 to the healthcare claim transaction 218. In one example embodiment, the rejection response may include a reason code or a text field that describes the reasons the transaction 218 was rejected (e.g., medication requested is not used to treat diagnosis of patient, pharmacy not a qualified pharmacy, healthcare provider/prescriber is not a covered entity/qualified prescriber, etc.). In step 364, the service provider computer 104 can transmit the rejection response 220 to the pharmacy computer 103 via, for example, the network 110. The process can then continue to the END step.

Returning to the YES branch of step 360, in step 366, the service provider computer 104 transmits the healthcare claim transaction 218 to the claims processor computer 106 for adjudication. For example, the healthcare claim transaction 218 can be transmitted from the service provider computer 104 to the claims processor computer 106 via the network 110. The claims processor computer 106 receives and adjudicates the healthcare claim transaction 218 in step 368 to determine if the patient has coverage, to determine to what extent the patient's coverage covers the requested medication identified in the transaction 218, and to generate an adjudication 222 as to whether the transaction 218 is approved or rejected. Example adjudications can include, but are not limited to, accepted, approved, paid, captured, denied, and denied with request for additional information and resubmission. In certain exemplary embodiments, the adjudication can be input into a field of the healthcare claim transaction 218 that is recognized by the service provider computer 104 and/or the pharmacy computer 103. Typically, if the transaction 218 is approved, the adjudicated response 222 provides the amount of the cost of the medication, product, or service that will be covered by the claims processor associated with the claims processor computer 106 and the patient co-pay amount and if rejected, the adjudicated response 222 provides the reason for the rejection (e.g., in the form of a reject code, for example, patient not covered, Cardholder ID submitted in the transaction is inactive, prior authorization required, medication not covered, etc.). In step 370, the claims processor computer 106 transmits the adjudicated healthcare claim transaction response 222 to the service provider computer 104 via, for example, the network 110.

The service provider computer 104 receives the adjudicated healthcare claim transaction response 222 from the claims processor computer 106 in step 372. In step 374, the service provider computer 104 transmits the adjudicated healthcare claim transaction response 222 to the pharmacy computer 103 via, for example, the network 110. In certain example embodiments, the service provider computer 104 may also include message information either in the adjudicated response 222, appended thereto, or generally sent along with, related to the adjudication, the evaluation of the transaction with regard to the 340B or other qualified program, or other information for the pharmacist or the patient. The pharmacy computer 103 receives the adjudicated healthcare claim transaction response 222 from the service provider computer 104 in step 376. In step 378, the pharmacist can provide the patient 202 with the requested medication from the prescription if the adjudicated response 222 is approved/paid. The process continues to the END step.

The methods described and shown in FIGS. 3A-B may be carried out or performed in any suitable order as desired in various embodiments. Additionally, in certain exemplary embodiments, at least a portion of the operations may be carried out in parallel. Furthermore, in certain exemplary embodiments, less than or more than the operations described in FIGS. 3A-B may be performed.

FIG. 2B illustrates a variation of the block diagram of FIG. 2A that has been discussed in conjunction with FIGS. 3A and 3B. As shown in FIG. 2B, the service provider 104 may be comprised of two or more distinct service providers 104a and 104b that are in communication with each other. Service provider 104a may be operative with the pharmacy computer 103 and the claims processor 106 while service provider 104b may be operative with other pharmacy computers and claims processors. However, service provider 104b may have a data processing arrangement with service provider 104a. Under the data processing agreement, the service provider 104a may be permitted to utilize or offer services of the service provider 104b, including the qualifying program eligibility verification module 109. Accordingly, the services of the service provider 104b, including the qualifying program eligibility verification module 109, may be available to the pharmacy computer 103 via the service providers 104a.

Accordingly, example embodiments disclosed herein can provide the technical effects of creating a system and methods that provide a real-time or near real time way to verify correlation of diagnosis and medication being prescribed to a patient as part of qualifying program eligibility verification conducted during the processing of a healthcare transaction. In this regard, fraud and mistakes with regard to whether pharmacies, prescribers, and healthcare providing entities qualify under a qualified program, such as a 340B program are reduced.

Various block and/or flow diagrams of systems and methods and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, that includes a computer usable medium having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of those set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method, comprising:
receiving, by one or more computers comprising one or more processors, a first healthcare transaction comprising at least one patient identifier identifying a patient and a diagnosis code for a diagnosis for the patient;
receiving, by the one or more computers from a pharmacy computer associated with a pharmacy a second healthcare transaction, the second healthcare transaction comprising a medication identifier for a medication and at least one of the at least one patient identifier for the patient;
determining, by the one or more computers and based at least in part on the diagnosis code, at least one treatment medication for treating a malady identified by the diagnosis code;
comparing, by the one or more computers, the medication identifier to the at least one treatment medication to determine if the medication identified by the medication identifier is at least one of the treatment medications for treating the malady identified by the diagnosis code;
determining, by the one or more computers, if the second healthcare transaction is eligible under a predetermined qualifying program; and
transmitting, by the one or more computers to a claims processor computer associated with a claims processor, the second healthcare transaction for adjudication based at least on a positive determination that the medication identified by the medication identifier is at least one of the treatment medications for treating the malady identified by the diagnosis code and the second healthcare transaction is eligible under a predetermined qualifying program.

2. The computer-implemented method of claim 1, further comprising:
generating, by the one or more computers, a rejection of the second healthcare transaction based at least in part on a negative determination that the medication identified by the medication identifier is at least one of the treatment medications for treating the malady identified by the diagnosis code or the second healthcare transaction is eligible under a predetermined qualifying program; and
transmitting, by the one or more computers, the rejection of the second healthcare transaction to the pharmacy computer.

3. The computer-implemented method of claim 1, further comprising:
receiving, by the one or more computers, patient registration information from a covered entity computer associated with a covered entity, wherein the patient registration information comprises patient identification information identifying the patient;
wherein determining if the second healthcare transaction is eligible under the predetermined qualifying program comprises comparing the at least one patient identifier in the second healthcare transaction to the patient identification information in the patient registration information to determine if the at least one patient identifier matches at least a portion of the patient identification information.

4. The computer-implemented method of claim 1, further comprising:
receiving, by the one or more computers from a covered entity computer associated with a covered entity healthcare provider, a prescriber registration comprising a prescriber identifier for a prescriber within the covered entity healthcare provider;
wherein the second healthcare transaction further comprises a second prescriber identifier identifying a prescriber of the medication, and
wherein determining if the second healthcare transaction is eligible under the predetermined qualifying program comprises comparing the second prescriber identifier to the first prescriber identifier to determine if the second prescriber identifier matches the first prescriber identifier.

5. The computer-implemented method of claim 1, further comprising:
identifying, by the one or more computers, the diagnosis code in the first healthcare transaction;
modifying the first healthcare transaction by modifying at least one of the location and format of the diagnosis code identified in the first healthcare transaction.

6. The computer-implemented method of claim 1, further comprising:
receiving, by the one or more computers from a covered entity computer associated with a covered entity healthcare provider, a prescriber registration comprising at least one first covered entity identifier identifying a covered entity healthcare provider;
wherein the second healthcare transaction further comprises a second covered entity identifier, and
wherein determining if the second healthcare transaction is eligible under the predetermined qualifying program comprises comparing the second covered entity identifier to the at least one first covered entity identifier to determine if the second covered entity identifier matches at least a portion of the at least one first covered entity identifier.

7. The computer-implemented method of claim 1, wherein the first healthcare transaction is an admit, discharge, transfer (ADT) transaction.

8. The computer-implemented method of claim 1, wherein the second healthcare transaction is a healthcare claim transaction.

9. The computer-implemented method of claim 1, further comprising:
receiving, by the one or more computers from the claims processor computer, an adjudicated second healthcare transaction response;
transmitting, by the one or more computers, the adjudicated second healthcare transaction response to the pharmacy computer.

10. The computer-implemented method of claim 1, further comprising receiving, by the one or more computers from the pharmacy computer, a diagnosis correlation comprising a plurality of diagnosis codes and at least one treatment medication identifier for each of the plurality of diagnosis codes, wherein each treatment medication identifier identifies a treatment medication for treating a malady identified by the respective diagnosis code.

11. A system, comprising:
at least one memory operable to store computer-executable instructions; and
at least one processor configured to access the at least one memory and execute the computer-executable instructions to:
receive a first healthcare transaction comprising at least one patient identifier identifying a patient and a diagnosis code for a diagnosis for the patient;
receive, from a pharmacy computer associated with a pharmacy, a second healthcare transaction, the second healthcare transaction comprising a medication identifier for a medication and at least one of the at least one patient identifier for the patient;
determine, based at least in part on the diagnosis code, at least one treatment medication for treating a malady identified by the diagnosis code;
compare the medication identifier to the at least one treatment medication to determine if the medication identified by the medication identifier is at least one of the treatment medications for treating the malady identified by the diagnosis code;
determine if the second healthcare transaction is eligible under a predetermined qualifying program; and
direct communication of the second healthcare transaction to a claims processor computer associated with a claims processor for adjudication based at least on a positive determination that the medication identified by the medication identifier is at least one of the treatment medications for treating the malady identified by the diagnosis code and the second healthcare transaction is eligible under a predetermined qualifying program.

12. The system of claim 11, wherein the at least one processor is further configured to access the at least one memory and execute the computer-executable instructions to:
generate a rejection of the second healthcare transaction based at least in part on a negative determination that the medication identified by the medication identifier is at least one of the treatment medications for treating the malady identified by the diagnosis code or the second healthcare transaction is eligible under a predetermined qualifying program; and
direction communication of the rejection of the second healthcare transaction to the pharmacy computer.

13. The system of claim 11, wherein the at least one processor is further configured to access the at least one memory and execute the computer-executable instructions to:
receive patient registration information from a covered entity computer associated with a covered entity, wherein the patient registration information comprises patient identification information identifying the patient;
wherein determining if the second healthcare transaction is eligible under the predetermined qualifying program comprises comparing the at least one patient identifier in the second healthcare transaction to the patient identification information in the patient registration information to determine if the at least one patient identifier matches at least a portion of the patient identification information.

14. The system of claim 11, wherein the at least one processor is further configured to access the at least one memory and execute the computer-executable instructions to:
Receive, from a covered entity computer associated with a covered entity healthcare provider, a prescriber registration comprising a prescriber identifier for a prescriber within the covered entity healthcare provider;
wherein the second healthcare transaction further comprises a second prescriber identifier identifying a prescriber of the medication to the patient, and
wherein determining if the second healthcare transaction is eligible under the predetermined qualifying program comprises comparing the second prescriber identifier to the first prescriber identifier to determine if the second prescriber identifier matches the first prescriber identifier.

15. The system of claim 11, wherein the at least one processor is further configured to access the at least one memory and execute the computer-executable instructions to:
identify the diagnosis code received in the first healthcare transaction;
modify the first healthcare transaction by modifying at least one of the location and format of the diagnosis code identified in the first healthcare transaction.

16. The system of claim 11, wherein the at least one processor is further configured to access the at least one memory and execute the computer-executable instructions to:
receive, from a covered entity computer associated with a covered entity healthcare provider, a prescriber registration comprising at least one first covered entity identifier identifying a covered entity healthcare provider;
wherein the second healthcare transaction further comprises a second covered entity identifier, and
wherein determining if the second healthcare transaction is eligible under the predetermined qualifying program comprises comparing the second covered entity identifier to the at least one first covered entity identifier to determine if the second covered entity identifier matches at least a portion of the at least one first covered entity identifier.

17. The system of claim 11, wherein the first healthcare transaction is an admit, discharge, transfer (ADT) transaction.

18. The system of claim 11, wherein the second healthcare transaction is a healthcare claim transaction.

19. The system of claim 11, wherein the at least one processor is further configured to access the at least one memory and execute the computer-executable instructions to:
receive, from the claims processor computer, an adjudicated second healthcare transaction response;
direct communication of the adjudicated second healthcare transaction response to the pharmacy computer.

20. The system of claim 11, wherein the predefined qualifying program is one of at least: (i) a federal 340B program; (ii) a section 602 pricing; (iii) a group purchasing organizations (GPO) program; (iv) a patient assistance program (PAP); (v) Medicare; or (vi) Medicaid.
